(19) United States
(12) Patent Application Publication
(10) Pub. No.: US 2007/0006967 A1
(43) Pub. Date: Jan. 11, 2007

(54) Adhesion system and method

(76) Inventors: Henry M. Sanftleben, Carmel, IN (US); Eric M. Berg, Russiaville, IN (US); Mary Beth Young, Atlanta, IN (US); Morris D. Stillabower, Tipton, IN (US); Sathur N. Venkatesan, Lafayette, IN (US)

Correspondence Address: Delphi Technologies, Inc., M/C 480-410-202, P.O. Box 5052, Troy, MI, 48007-5052, US

(21) Appl. No.: 11/176,415

(22) Filed: Jul. 7, 2005

(51) Int. Cl. B32B 37/12; B32B 38/00; B32B 7/12

(52) U.S. Cl. 156/275.7; 156/330; 156/331.7; 428/343; 428/355 R

(57) ABSTRACT

A method for connecting a first substrate to a second substrate by exposing at least a portion of the first substrate to ultraviolet light for a predetermined time interval and contacting the first substrate and the second substrate with an adhesive such that the adhesive is positioned between the exposed portion of the first substrate and the second substrate. In one aspect, the exposed portion includes a poly(p-phenylene sulfide) material.

### BACKGROUND

The present application relates to the improved adhesion of adhesives and, more particularly, the improved adhesion of silicone adhesives to poly(p-phenylene sulfide).

Poly(p-phenylene sulfide) (“PPS”) is a polymer comprised of alternating sulfur atoms and phenylene rings in a para-substituted pattern, as shown below:

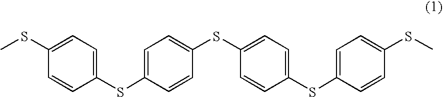

The highly stable chemical bonds in the molecular structure of PPS impart a remarkable degree of molecular stability towards thermal and chemical degradation. Furthermore, PPS has been known to have good UV stability. The molecular structure of PPS readily packs into a thermally stable crystalline lattice and therefore may be considered a semi-crystalline polymer having a high crystalline melting point of about 285° C. Because of its molecular structure, PPS tends to char during combustion, thereby making the material inherently flame retardant. Furthermore, PPS has not been found to dissolve in any solvent at temperatures below about 200° C.

PPS typically is blended with glass fibers and the like to produce engineering plastics having unique combinations of properties, such as long-term and short-term thermal stability, high modulus and creep resistance, improved resistance to chemical degradation, good moldability, inherent nonflameability and insulating properties stable over a wide range of conditions.

Accordingly, PPS and composites of PPS may be used as substrates for manufacturing various devices, components and parts including, but not limited to, molded parts such as housings, connectors and the like.

Adhesives, such as silicone adhesives, typically are used to connect parts and devices molded from various polymers and the like. However, due to the high chemical resistivity of PPS polymers, manufacturers often encounter difficulties when attempting to bond adhesives to PPS substrates.

The prior art has suggested several techniques for improving adhesion to PPS substrates. For example, the prior suggests using plasma, flame or corona treatments to modify the surface of the PPS substrate, thereby improving adhesion. However, such techniques may have a detrimental effect on the PPS substrate. For example, such treatments may damage sensitive components associated with or connected to the substrate (e.g., electrical connections, wire bonding pins or electrical connection sites) and may degrade or contaminate the substrate.

Accordingly, there is a need for an improved method for bonding adhesives to PPS substrates.

### SUMMARY

In one aspect, the improved adhesion system and method provides a method for connecting a first substrate to a second substrate. The method includes the steps of exposing at least a portion of the first substrate to ultraviolet light for a predetermined amount of time, applying an adhesive and contacting the first substrate with the second substrate such that the adhesive is positioned between the exposed portion of the first substrate and the second substrate.

In another aspect, the improved adhesion system and method provides a method for improving the adhesion of an adhesive to a PPS-based substrate. The method includes exposing at least a portion of the PPS-based substrate to ultraviolet light for a predetermined about of time and applying the adhesive to at least a portion of the exposed portion of the PPS-based substrate.

In another aspect, the improved adhesion system and method provides an adhesive system including a silicone adhesive and a PPS-based substrate, wherein the PPS-based substrate is exposed to ultraviolet light for at least about 15 minutes prior to contacting the PPS-based substrate with the silicone adhesive.

Other aspects of the improved adhesion system and method will become apparent from the following description, the accompanying drawings and the appended claims.

### BRIEF DESCRIPTION OF THE DRAWINGS

FIG. 1A is a front elevational view of a device assembled according to the improved adhesion system and method;

FIG. 1B is a front elevational view of a first connecting portion of the device of FIG. 1A;

FIG. 1C is a front elevational view of a second connecting portion of the device of FIG. 1A; and

FIG. 2 is a schematic illustration of an adhesive engaging a PPS substrate according to the improved adhesion system and method.

### DETAILED DESCRIPTION

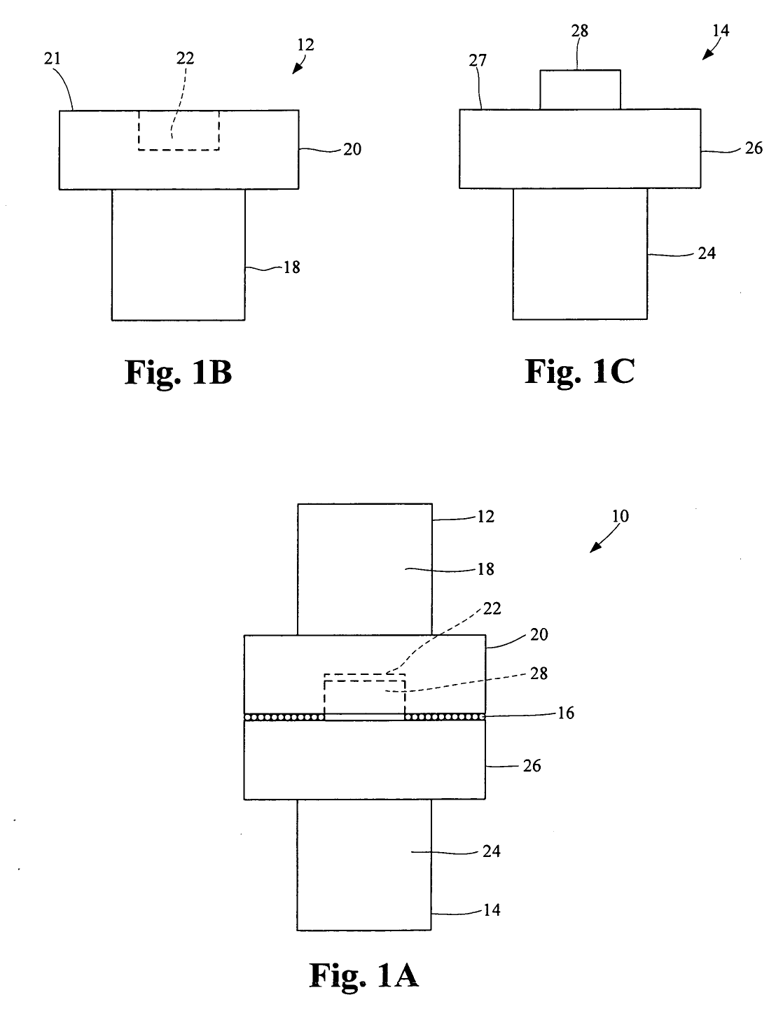

As shown in FIGS. 1A, 1B and 1C, a device 10 may be formed by connecting a first connecting portion 12 to a second connecting portion 14 using an adhesive 16. The first connecting portion 12 may include an elongated shaft portion 18, a flange 20 and a female portion of an electrical connection 22. The flange 20 may include an engaging surface 21. The second connecting portion 14 may include a shaft 24, a flange 26 and a male portion of an electrical connection 28 sized and shaped to engage the female connection 22. The flange 26 may include an engaging surface 27.

The device 10 may be assembled by connecting the first portion 12 to the second portion 14 such that the engaging surface 21 engages the engaging surface 27 and the male connection 28 engages the female connection 22, as shown in FIG. 1C. An adhesive 16 may be applied to the engaging surface 21 and/or the engaging surface 27 to secure the first portion 12 to the second portion 14. The adhesive may be sandwiched between the engaging surfaces 21, 27.

The connecting portions 12, 14 may be formed from a PPS substrate (or PPS-based substrate). The PPS substrate may be any polymeric material including at least a portion of PPS or at least a portion of a polymeric material derived from PPS. The PPS substrate may be coated with PPS or may include PPS dispersed therein.

The substrate may be formed and shaped in any known way. For example, the substrate may be molded, injection molded, extruded, forged, cut, lathed or processed by any known means for forming and/or shaping polymeric parts and components. In one aspect, the PPS substrate may include reinforcing fibers, strings or strands dispersed in a PPS polymeric matrix to add structural reinforcement to the substrate.

The adhesive 16 may be any adhesive capable of engaging a PPS substrate. In one aspect, the adhesive 16 may be a silicone adhesive, organo-functional silanes, methoxy silanes, ethoxy silanes, propyl silanes and the like and may be based on silane, silicone, epoxy and/or urethane chemistry. For example, and without limitation, the adhesive may be DC 3-6265, DC 3-6611, DC 3-1598, DC 3140, DC 3145 RTV, DC3-1595, DC 3-1744, DC 3-1598HP, Tough Gel 3-4207 and Firm Gel DC 3-4220, available from Dow Corning, KE347TUV, available from Shin-Etsu Silicones, RTV 5818 Translucent, available from GE Silicones, and Heavy Body 5900 RTV, available from Loctite.

In one aspect, the adhesion of the adhesive 16 to the PPS substrate may be improved by exposing the PPS substrate to ultraviolet light. As used herein, ultraviolet light includes electromagnetic radiation having a wavelength of about 10 nanometers to about 380 nanometers. It should be understood that the entire PPS substrate may be exposed to ultraviolet light or only a portion of the PPS substrate (e.g., the engaging surfaces 21, 27) may be exposed to ultraviolet light.

The substrate to be treated with ultraviolet light may be exposed to an ultraviolet lamp or multiple ultraviolet lamps. In one aspect, the ultraviolet lamp may be a 254 nanometer ultraviolet lamp. In another aspect, the ultraviolet lamp may be a 254 nanometer ultraviolet zig-zag lamp.

In one aspect, the substrate may be positioned about 0.25 inches to about 10 inches from the ultraviolet lamp. In another aspect, the substrate may be positioned about 0.1 inches to about 100 inches from the ultraviolet lamp.

In one aspect, the PPS substrate may be exposed to ultraviolet light for about 5 minutes to about 18 hours or more. In another aspect, the PPS substrate may be exposed to ultraviolet light for a minimum of 15, 30 or 60 minutes. In another aspect, the PPS substrate may be exposed to ultraviolet light for a minimum of 120 minutes. In another aspect, 100% cohesion may be obtained by exposing the substrate to ultraviolet light for 60 minutes with a ±15 minute safety factor.

It is believed that the ultraviolet light chemically modifies the PPS substrate to provide a surface that is chemically reactive with adhesives without degrading or damaging the PPS substrate or the components formed from the PPS substrate (e.g., connecting portions 12, 14 of the electrical connections 22, 28).

Without being limited to any particular theory, it is believed that the ultraviolet light excites sulfur atoms in the PPS chain to creates free radicals and/or free electrons, thereby allowing local oxygen (e.g., O₂ in the air and/or O₃ created by the ultraviolet light) to bond with the sulfur atoms and form sulfur-oxygen bonds, as shown below:

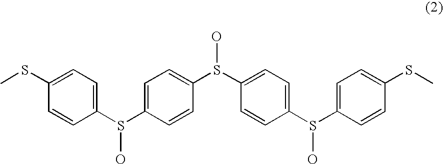

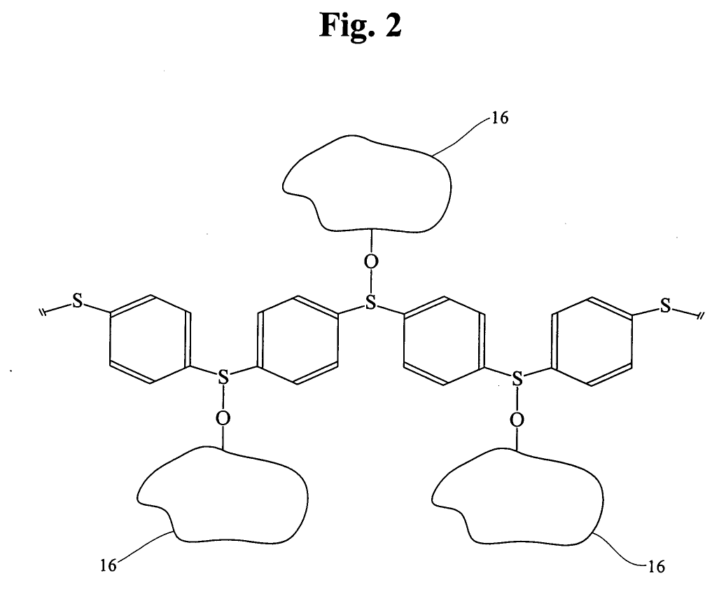

The sulfur-oxygen bonds provide a reactive site where the adhesive 16 can react with the modified PPS chain, as shown in FIG. 2, thereby allowing the adhesive to bond or adhere to the PPS substrate.

Electron spectroscopy for chemical analysis (ESCA) has verified that ultraviolet light alters the chemistry of the sulfer bonds in the PPS chain. In particular, the ESCA data has verified that PPS substrates exposed to ultraviolet light have increased absorptions corresponding to an increase in sulfur-oxygen bonds.

Accordingly, referring to FIGS. 1A, 1B and 1C, the engaging surfaces 21, 27 of the device 10 may be exposed to ultraviolet light, as described above, to improve the adhesion of the adhesive 16 to the engaging surfaces 21, 27, thereby providing a stronger connection between the first and second connecting portions 12, 14.

### EXAMPLE

The engaging surfaces of nine PPS connector assemblies having a first connecting portion and a second connecting portion were positioned approximately 2 inches under the ring light flame of a fluorescent ring bulb assembly, wherein the fluorescent light bulb was replaced with a 30 W ultraviolet ring bulb. The ultraviolet ring bulb was replacement bulb from FloTron (model BF180). The connectors were exposed to ultraviolet light for approximately 18 hours.

After the 18-hour exposure, each of the connectors was manually assembled using Dow 6265 adhesive. About 0.75 g to about 0.8 g of adhesive was applied to each connector. The connectors were allowed to cure for about 1½ hours at 125° C. in a manual oven. Once the connectors were cured, each of the nine connectors was subjected to Instron testing. The results are provided at Table 1.

TABLE 1

| Unit | Peak Force (lb_{f}) |
|---|---|
| 1 | 509.1 |
| 2 | 411.1 |
| 3 | 474.8 |
| 4 | 365.6 |
| 5 | 392.6 |
| 6 | 383.2 |
| 7 | 477.4 |
| 8 | 484.0 |
| 9 | 377.4 |

All nine of the units exhibited a 100 percent cohesive failure (i.e., there were no adhesive faliures). Furthermore, the connectors treated with ultraviolet light exhibited peak force increases of up to about 750% with respect to untreated connectors.

Accordingly, the adhesion or bonding of adhesives to PPS substrates may be improved by exposing the PPS substrates to ultraviolet light prior to applying the adhesives.

Although the improved adhesion system and method is shown and described with respect to certain aspects, is should be understood that modifications will occur to those skilled in the art upon reading the specification. The improved adhesion system and method includes all such modifications and is limited only by the scope of the claims.

What is claimed is:

1. A method for connecting a first substrate to a second substrate comprising the steps of:
exposing at least a portion of said first substrate to ultraviolet light for a predetermined time interval;
applying an adhesive; and
contacting said adhesive with said first substrate and said second substrate such that said adhesive is positioned between said exposed portion of said first substrate and said second substrate.

2. The method of claim 1 wherein said exposed portion includes a poly(p-phenylene sulfide) material.

3. The method of claim 2 wherein said poly(p-phenylene sulfide) material includes a reinforcing material.

4. The method of claim 1 wherein at least a portion of said second substrate includes a poly(p-phenylene sulfide) material.

5. The method of claim 4 further comprising the step of exposing said at least a portion of said second substrate to ultraviolet light for said predetermined time interval.

6. The method of claim 1 wherein said ultraviolet light includes light having a wavelength of about 10 nanometers to about 380 nanometers.

7. The method of claim 1 wherein said predetermined time interval is about 1 hour to about 20 hours.

8. The method of claim 1 wherein said predetermined time interval is about 15 minutes to about 90 minutes.

9. The method of claim 1 wherein said adhesive includes at least one of a silicone adhesive, an organo-functional silane, a methoxy silane, an ethoxy silane, a propyl silane, an epoxy and a urethane.

10. The method of claim 1 wherein said adhesive is selected from the group consisting of DC 3-6265, DC 3-6611, DC 3-1598, DC 3140, DC 3145 RTV, DC3-1595, DC 3-1744, DC 3-1598HP, Tough Gel 3-4207, Firm Gel DC 3-4220, KE347TUV, RTV 5818 Translucent and Heavy Body 5900 RTV.

11. The method of claim 1 further comprising the step of curing said adhesive.

12. A method for improving the adhesion of an adhesive to a PPS-based substrate comprising the steps of:
exposing at least a portion of said PPS-based substrate to ultraviolet light for a predetermined time interval; and
applying said adhesive to at least a portion of said exposed portion of said PPS-based substrate.

13. The method of claim 12 wherein said ultraviolet light includes light having a wavelength of about 10 nanometers to about 380 nanometers.

14. The method of claim 12 wherein said predetermined time interval is at least about 30 minutes.

15. The method of claim 12 wherein said adhesive includes at least one of a silicone adhesive, an organo-functional silane, a methoxy silane, an ethoxy silane, a propyl silane, an epoxy and a urethane.

16. The method of claim 12 wherein said adhesive is selected from the group consisting of DC 3-6265, DC 3-6611, DC 3-1598, DC 3140, DC 3145 RTV, DC3-1595, DC 3-1744, DC 3-1598HP, Tough Gel 3-4207, Firm Gel DC 3-4220, KE347TUV, RTV 5818 Translucent and Heavy Body 5900 RTV.

17. An adhesive system comprising:
a silicone adhesive; and
a PPS-based substrate contacting said silicone adhesive, wherein said PPS-based substrate is exposed to ultraviolet light for at least about 15 minutes prior to contacting said PPS-based substrate with said silicone adhesive.

18. The system of claim 17 wherein said silicone adhesive includes at least one of an organo-functional silane, a methoxy silane, an ethoxy silane, a propyl silane, an epoxy and a urethane.

19. The system of claim 17 wherein said silicone adhesive is selected from the group consisting of DC 3-6265, DC 3-6611, DC 3-1598, DC 3140, DC 3145 RTV, DC3-1595, DC 3-1744, DC 3-1598HP, Tough Gel 3-4207, Firm Gel DC 3-4220, KE347TUV, RTV 5818 Translucent and Heavy Body 5900 RTV.

20. The system of claim 17 wherein said ultraviolet light includes a light having a wavelength of about 10 nanometers to about 380 nanometers.
